(19) United States
(12) Patent Application Publication
(10) Pub. No.: US 2013/0089788 A1
(43) Pub. Date: Apr. 11, 2013

(54) METHOD FOR PRODUCING CONDUCTING MATERIAL, CONDUCTING MATERIAL, AND BATTERY

(71) Applicant: Tatsuya Furuya, Tokyo (JP)

(72) Inventor: Tatsuya Furuya, Tokyo (JP)

(73) Assignee: SONY CORPORATION, Tokyo (JP)

(21) Appl. No.: 13/704,428

(22) PCT Filed: Apr. 25, 2011
(86) PCT No.: PCT/JP2011/060567

§ 371 Date: Dec. 14, 2012

(30) Foreign Application Priority Data
Jun. 23, 2010 (JP) 2010-142548

(51) Int. Cl. H01M 4/485; H01M 4/04

(52) U.S. Cl. CPC H01M 4/485; H01M 4/0426
USPC 429/231.1; 423/598; 204/192.15

(57) ABSTRACT

Provided are a method for producing a novel conducting material which functions as an active material and has electron conductivity, the conducting material, and a battery.

The conducting material has conductivity imparted by applying a high-frequency wave to a Li₄Ti₅O₁₂ sintered body to change the chemical state of titanium. This conducting material is, for example, a target after carrying out RF magnetron sputtering in an atmosphere containing nitrogen with the use of a Li₄Ti₅O₁₂ sintered body as a target.

### TECHNICAL FIELD

The present invention relates to a method for producing a conducting material, the conducting material, and a battery.

### BACKGROUND ART

Ceramic materials have been used as industrial materials in various machine tools, machine elements and the like. In recent years, in electrical and electronic fields, there is a growing need for conducting ceramic materials which exhibit electrical conductivity.

Ceramic materials such as Li₄Ti₅O₁₂, which are used for active materials of lithium ion secondary batteries, have no or poor electrical conductivity, and thus commonly constitute electrodes along with conducting agents such as carbon black and acetylene black.

Patent Document 1 discloses a technique of heating powder of titanium dioxide under a nitrogen gas atmosphere to prepare a conductive active material TiO_{1.7}N_{0.3}.

### CITATION LIST

### Patent Document

Patent Document 1: Japanese Patent Application Laid-Open No. 2006-32321

### SUMMARY OF THE INVENTION

### Problems to be Solved by the Invention

When a conducting agent is mixed to constitute an electrode along with a ceramic material such as Li₄Ti₅O₁₂ which functions as an active material, the negative electrode or positive electrode section used per unit amount (mass, volume) of the active material will be reduced to decrease the capacity per unit amount. In addition, if the active material has no conductivity, the rate performance will be degraded.

Therefore, an object of the invention of the present application is to provide a method for producing a novel conducting material which functions as an active material and has electron conductivity, the conducting material, and a battery.

### Solutions to Problems

In order to solve the problems mentioned above, a first aspect of the present invention is a method for producing a conducting material, including the step of carrying out treatment of applying a high-frequency wave to Li₄Ti₅O₁₂.

A second aspect of the invention is a conducting material in which a chemical state of titanium has been changed by carrying out treatment of applying a high-frequency wave to Li₄Ti₅O₁₂.

A third aspect of the invention is a battery including: a positive electrode; a negative electrode; and an electrolyte, wherein the negative electrode contains, as an active material, a conducting material in which a chemical state of titanium has been changed by carrying out treatment of applying a high-frequency wave to Li₄Ti₅O₁₂.

In the first to third aspects of the invention, electron conductivity can be achieved by carrying out the treatment of applying a high-frequency wave to the Li₄Ti₅O₁₂ to change the chemical state of titanium.

### Effects of the Invention

The present invention can provide a method for producing a novel conducting material which functions as an active material and has electron conductivity, the conducting material, and a battery.

### BRIEF DESCRIPTION OF DRAWINGS

FIG. 1 is a cross-sectional view illustrating a constitutional example of a non-aqueous electrolyte battery according to an embodiment of the present invention.

FIG. 2 is an enlarged cross-sectional view of a rolled electrode body in FIG. 1.

FIG. 3 is a photograph showing conducting materials according to Example 1 and Reference Example 1.

FIG. 4 is an XRD pattern for a conducting material in Example 1.

FIG. 5 is an XPS spectrum for a conducting material in Example 1.

### MODE FOR CARRYING OUT THE INVENTION

Embodiments of the present invention will be described below with reference to the drawings. It is to be noted that the description will be carried out in the following order.

### 1. First Embodiment (Example of Conducting Material)

### 2. Second Embodiment (Example of Battery)

### 3. Other Embodiment (Modified Example)

### 1. FIRST EMBODIMENT

A conducting material according to a first embodiment of the present invention will be described. The conducting material according to the first embodiment of the present invention has conductivity imparted by applying a high-frequency wave to a Li₄Ti₅O₁₂ sintered body to change the chemical state of titanium.

For example, this conducting material is a target after carrying out RF (radio frequency) magnetron sputtering in an atmosphere containing nitrogen with the use of a Li₄Ti₅O₁₂ sintered body as a target. This target after the sputtering is a novel conducting material in which a Li₄Ti₅O₁₂ phase, a rutile-type TiO₂ phase, and an anatase-type TiO₂ phase are confirmed by an XRD (X-Ray Diffraction) analysis. In addition, it is confirmed by an XPS (X-ray photoelectron spectroscopy) analysis that the Ti2p3/2 peak of the target after the sputtering is shifted to the lower energy side as compared with the target before the sputtering, indicating that the chemical state of titanium has been changed. It is to be noted that the Li₄Ti₅O₁₂ sintered body can be obtained, for example, by molding and sintering of Li₄Ti₅O₁₂ powder synthesized by a solid-phase reaction method with Li₂CO₃ power and TiO₂ powder as raw materials.

For example, when the Li₄Ti₅O₁₂ sintered body is placed in RF magnetron sputtering equipment to carry out sputtering with power output: 50 W, Ar: 10 sccm, and N₂: 10 sccm, the Li₄Ti₅O₁₂ sintered body after the sputtering will have conductivity. This example represents a value of 2 kΩ/sq in the case of measuring the surface resistivity by a four-probe method.

### 2. SECOND EMBODIMENT

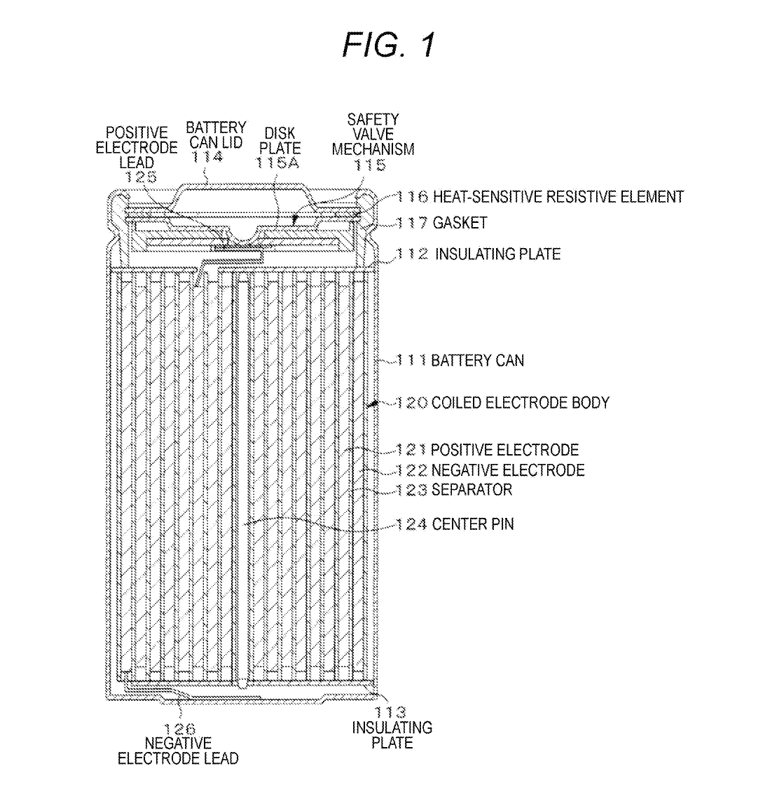

A battery according to a second embodiment of the present invention will be described. FIG. 1 is a cross-sectional view illustrating a constitutional example of the battery according to the second embodiment of the present invention. This battery uses, as a negative electrode active material, the conducting material according to the first embodiment described above.

### [Configuration of Battery]

FIG. 1 illustrates a cross-sectional structure of the battery according to the second embodiment of the present invention. This battery is a non-aqueous electrolyte battery which uses an electrolytic solution including an organic solvent. In addition, this battery is a lithium ion secondary battery which has a negative electrode capacity represented by a capacity component based on the storage and release of lithium as an electrode reaction substance. This battery has a battery structure referred to as a cylindrical shape.

This battery includes, in an almost hollow cylindrical battery can 111, a rolled electrode body 120 and a pair of insulating plates 112 and 113. The rolled electrode body 120 includes a positive electrode 121 and a negative electrode 122 rolled with a separator 123 interposed therebetween. The battery can 111 is formed of, for example, iron (Fe) with nickel (Ni) plating applied, which has one end closed and the other end opened. The pair of insulating plates 112, 113 is arranged so as to sandwich the rolled electrode body 120, and extend perpendicular to the rolled peripheral surface.

The open end of the battery can 111 has a battery can lid 114, and a safety valve mechanism 115 and a heat-sensitive resistive element (Positive Temperature Coefficient; PTC element) 116 provided inside the lid, which are attached to the can by swaging with a gasket 117 interposed, so that the battery can 111 is hermetically sealed. The battery can lid 114 is formed of, for example, the same material as the battery can 111. The safety valve mechanism 115 is electrically connected to the battery can lid 114 through the heat-sensitive resistive element 116.

The safety valve mechanism 115 is adapted to cut the electrical connection between the battery can lid 114 and the rolled electrode body 20 by inversion of a disk plate 115A, when the internal pressure reaches a certain pressure or more due to internal short-circuit or external heating. The heat-sensitive resistive element 116 is for limiting the electric current by increasing the resistance according to the increase in temperature, and for preventing abnormal heat from being generated by a large electric current. The gasket 117 is formed of, for example, an insulating material, and asphalt is applied to the surface thereof.

For example, a center pin 124 is inserted in the center of the rolled electrode body 120. In the case of the rolled electrode body 120, a positive electrode lead 125 formed of aluminum (Al) or the like is connected to the positive electrode 121, whereas a negative electrode lead 126 formed of nickel or the like is connected to the negative electrode 122. The positive electrode lead 125 is welded to the safety valve mechanism 115, and thereby electrically connected to the battery can lid 114, whereas the negative electrode lead 126 is welded to, and thereby electrically connected to, the battery can 111.

### (Positive Electrode)

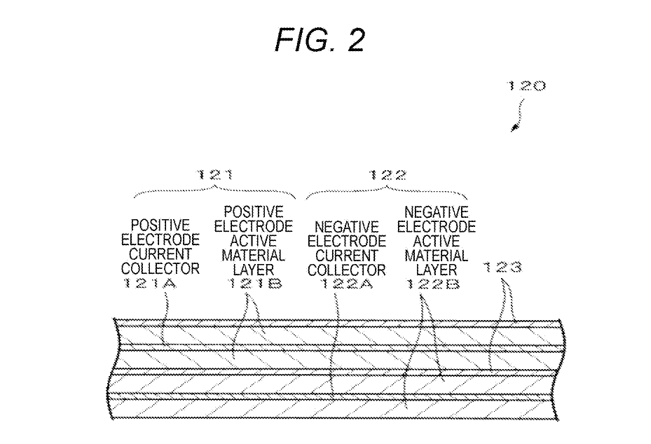

FIG. 2 shows an enlarged portion of the rolled electrode body 120 shown in FIG. 1. The positive electrode 121 has, for example, a positive electrode active material layer 121B provided on both sides of a positive electrode current collector 121A which has a pair of opposed surfaces. The positive electrode current collector 121A is formed of a metal material such as, for example, aluminum (Al), nickel (Ni), or stainless steel (SUS). The positive electrode active material layer 121B contains, as a positive electrode active material, a positive electrode material capable of storing and releasing lithium as an electrode reaction substance. This positive electrode active material layer 121B may contain a conducting agent and a binding agent, if necessary.

### (Positive Electrode Active Material)

For example, a lithium-containing compound is preferred as the positive electrode material capable of storing and releasing lithium. This is because a high energy density can be achieved. Examples of this lithium-containing compound include a composite oxide including lithium and a transition metal element, and a phosphate compound including lithium and a transition metal element. The chemical formula thereof is represented by, for example, LiₓM1O₂ or Li_{y}M2PO₄. In the formula, M1 and M2 represent one or more transition metal elements.

Examples of the composite oxide including lithium and a transition metal element include a lithium cobalt composite oxide (LiₓCoO₂), a lithium nickel composite oxide (LiₓNiO₂), a lithium nickel cobalt composite oxide (LiₓNi_{1-z}Co_{z}O₂ (z<1)), a lithium nickel cobalt manganese composite oxide (LiₓNi₍_{1-v-w})CoᵥMn_{w}O₂ (v+w<1)), a lithium nickel cobalt aluminum composite oxide (LiₓNi(_{1-v-w}) CoᵥAl_{w}O₂ (v+w<1)), and a lithium manganese composite oxide (LiMn₂O₄) which has a spinel-type structure. In addition, examples of the phosphate compound including lithium and a transition metal element include a lithium iron phosphate compound (LiFePO₄) and a lithium iron manganese phosphate compound (LiFe₁₋ᵤMnᵤPO₄ (u<1)).

Besides, examples of the positive electrode material capable of storing and releasing lithium also include oxides such as a titanium oxide, a vanadium oxide, or a manganese dioxide; disulfides such as a titanium disulfide or a molybdenum sulfide; chalcogen compounds such as niobium selenide; sulfur; and conducting polymers such as polyaniline or polythiophene.

The positive electrode material capable of storing and releasing lithium may be materials other than the materials mentioned above. In addition, two or more of the positive electrode materials given above as examples may be mixed in any combination.

### (Binding Agent)

Examples of the binding agent include fluorine-containing polymer compounds such as polyvinylidene fluoride (PVdF).

### (Conducting Agent)

Examples of the conducting agent include carbon materials such as graphite, carbon black, or Ketjen Black. These materials may be used alone or in mixture of two or more. It is to be noted that the conducting agent may be any metal material or conducting polymer, as long as the material or polymer is a conducting material.

### (Negative Electrode)

The negative electrode 122 has, for example, a negative electrode active material layer 122B provided on both sides of a negative electrode current collector 122A which has a pair of opposed surfaces. The negative electrode current collector 122A is formed of a metal material such as copper (Cu), nickel (Ni), or stainless steel (SUS). The negative electrode active material layer 122B contains, as a negative electrode active material, a negative electrode material capable of storing and releasing lithium. This negative electrode active material layer 122B may contain a conducting agent and a binding agent, if necessary.

### (Negative Electrode Active Material)

As the negative electrode material capable of storing and releasing lithium, the conducting material according to the first embodiment can be used. More specifically, a Li₄Ti₅O₁₂ sintered body with the chemical state of titanium changed by applying a high-frequency wave can be used as the negative electrode material. For example, the Li₄Ti₅O₁₂ sintered body after applying the high-frequency wave thereto is subjected to grinding or the like, and thereby used in the form of powder. This Li₄Ti₅O₁₂ sintered body after applying the high-frequency wave has conductivity, and functions as an active material. Therefore, for constituting the negative electrode 122, the conducting agent can be eliminated, or the amount of conducting agent can be reduced, and thus, the capacity per unit amount can be increased.

### (Conducting Agent)

Examples of the conducting agent include carbon materials such as graphite or carbon black. These materials may be used alone or in mixture of two or more. It is to be noted that the conducting agent may be any metal material or conducting polymer, as long as the material or polymer is a conducting material.

### (Binding Agent)

Examples of the binding agent include synthetic rubbers such as a styrene-butadiene rubber, a fluorine-containing rubber, and an ethylene-propylene-diene, and polymer materials such as polyvinylidene fluoride. These materials may be used alone or in mixture of two or more.

### (Electrolytic Solution)

The electrolytic solution includes a solvent and an electrolyte salt. Examples of the solvent include non-aqueous solvents such as: carbonate ester solvents such as ethylene carbonate, propylene carbonate, vinylene carbonate, dimethyl carbonate, ethylmethyl carbonate, and diethyl carbonate; ether solvents such as 1,2-dimethoxyethane, 1-ethoxy-2-methoxyethane, 1,2-diethoxyethane, tetrahydrofurane, and 2-methyltetrahydrofurane; lactone solvents such as γ-butyrolactone, γ-valerolactone, δ-valerolactone, and ε-caprolactone; nitrile solvents such as acetonitrile; sulfolane solvents; phosphoric acids; phosphate ester solvents; and pyrrolidones. Any one of the solvents may be used alone, or two or more thereof may be used in mixture.

For the electrolyte salt, lithium salts such as LiPF₆, LiClO₄, LiBF₄, LiN(CF₃SO₂)₂, LiN(C₂F₅SO₂)₂, and LiAsF₆ can be used. Any one of the lithium salts may be used alone, or two or more thereof may be used in mixture.

### (Separator)

The separator 123 is for separating the positive electrode 121 and the negative electrode 122 from each other, and allowing lithium ions to pass therethrough while preventing short circuit from being caused by an electric current due to the both electrodes in contact with each other. This separator 35 is formed of a porous membrane of a synthetic resin such as polytetrafluoroethylene, polypropylene, and polyethylene, or a porous membrane of ceramic, and may have a stacked structure of two or more of these porous membranes.

### (Production Method for Battery)

The battery described above is produced as follows, for example.

First, for example, the positive electrode 121 is prepared by forming the positive electrode active material layers 121B on both sides of the positive electrode current collector 121A. For the formation of the positive electrode active material layer 121B, a positive electrode mix, in which powder of the positive electrode active material, the conducting agent, and the binding agent are mixed, is dispersed in a solvent such as N-methyl-2-pyrrolidone to yield a positive electrode mix slurry in a paste form. Then, the positive electrode mix slurry is applied onto the positive electrode current collector 121A, dried, and then formed into a compact.

In addition, for example, a negative electrode mix, in which powder of the negative electrode active material, the conducting agent, if necessary, and the binding agent are mixed, is dispersed in a solvent such as N-methyl-2-pyrrolidone to yield a negative electrode mix slurry in a paste form. The negative electrode 122 is prepared by forming the negative electrode active material layers 122B on both sides of the negative electrode current collector 122A.

Next, the positive electrode lead 125 is attached by welding to the positive electrode current collector 121A, and the negative electrode lead 126 is attached by welding to the negative electrode current collector 122A.

Next, the rolled electrode body 120 is formed by rolling the positive electrode 121 and the negative electrode 122 with the separator 123 interposed therebetween. Then, after welding a tip of the positive electrode lead 125 to the safety valve mechanism 115 and welding a tip of the negative electrode lead 126 to the battery can 111, the rolled electrode body 120 sandwiched by the pair of insulating plates 112 and 113 is housed in the battery can 111.

Next, the electrolytic solution described above is injected into the battery can 111 to impregnate the separator 123 with the electrolytic solution. Finally, the battery can lid 114, the safety valve mechanism 115, and the heat-sensitive resistive element 116 are fixed to the open end of the battery can 111 by swaging with the gasket 117 interposed. In this manner, the battery can be obtained as shown in FIGS. 1 and 2.

### EXAMPLES

The present invention is specifically described below according to the examples, but the examples are merely to illustrate, but in no way to limit the invention.

### Example 1

### (Preparation of Target)

As raw material powders, Li₂CO₃ and TiO₂ were weighed in stoichiometric proportions and mixed with the use of a ball mill to yield mixed powder. Next, this mixed powder was subjected to firing in air at 800° C. for 12 hours to yield Li₄Ti₅O₁₂ powder. Next, the Li₄Ti₅O₁₂ powder was pressed and molded to a tablet with the use of a tablet press, followed by sintering in air at 800° C. for 6 hours to yield a sintered body of Li₄Ti₅O₁₂ for use as a target.

### (Preparation of Transparent Conductive Film)

Sputtering was carried out under the following conditions with the use of the Li₄Ti₅O₁₂ sintered body as a target and magnetron RF sputtering equipment.

### [Sputtering Conditions]

### Sputtering Pressure: 0.5 Pa

### Power Output: 50 W

Gas: Ar, 10 sccm and N₂, 10 sccm

### Reference Example 1

Sputtering was carried out under the following conditions with the use of the same Li₄Ti₅O₁₂ sintered body as in Example 1 as a target and magnetron RF sputtering equipment.

### [Sputtering Conditions]

### Sputtering Pressure: 0.5 Pa

### Power Output: 50 W

Gas: Ar, 10 sccm and O₂, 10 sccm
(Target after Sputtering)

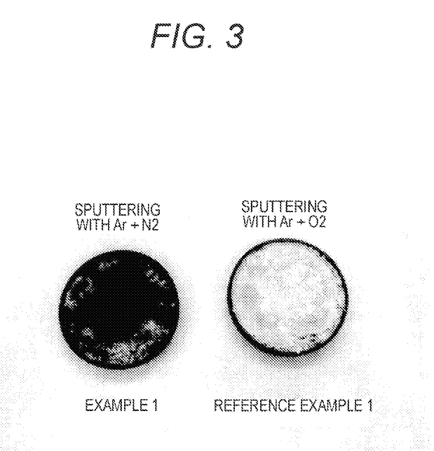

FIG. 3 shows a photograph of the targets after the sputtering in Example 1 and Reference Example 1. It has been confirmed that the target after the sputtering in Example 1 has a black surface.

### (Measurement of Resistivity)

The surface resistivity was measured by the four-probe method. The surface resistivity was 2 kΩ/sq in Example 1.

### (XRD Analysis)

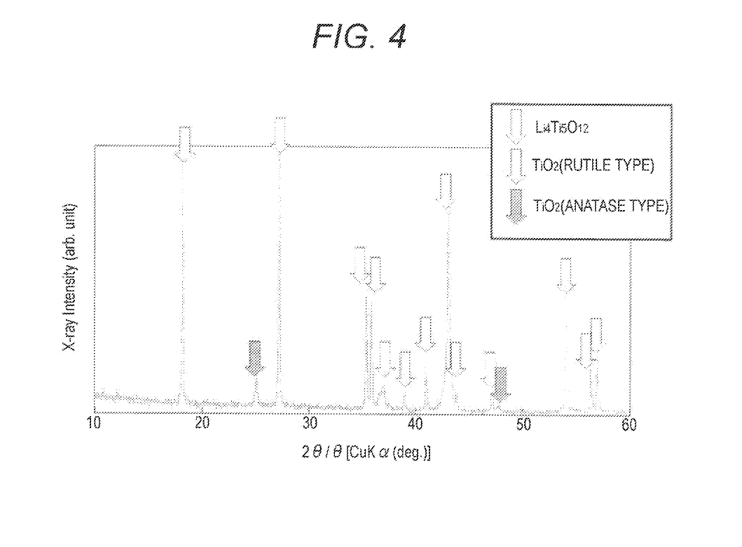

An XRD analysis was carried out on the target after the sputtering in Example 1. FIG. 4 is an XRD pattern for the conducting material in Example 1. As shown in FIG. 4, the peaks of rutile-type TiO₂ and the peaks of anatase-type TiO₂ were observed in addition to the peaks of Li₄Ti₅O₁₂ indicated by arrows.

### (XPS Analysis)

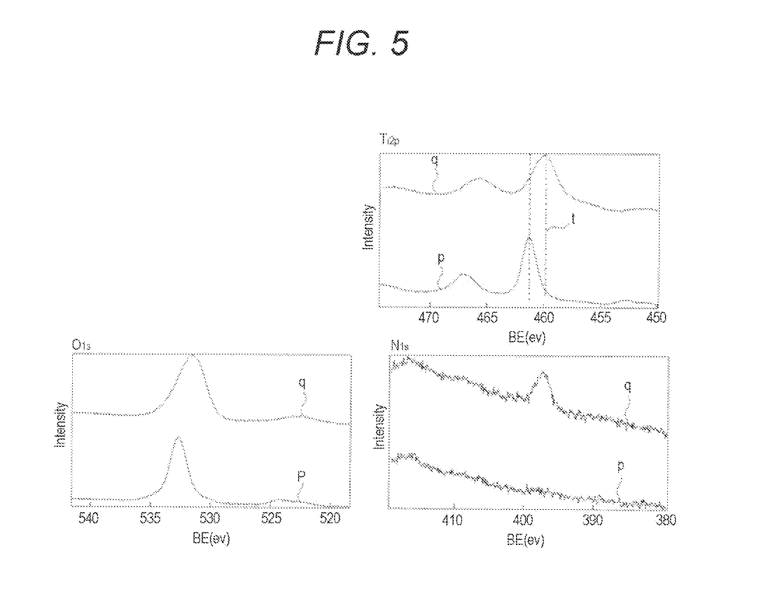

In Example 1, an XPS analysis was carried out on each of the target before the sputtering and the target after the sputtering. FIG. 5 shows the measurement results. In FIG. 5, a line p refers to an XPS spectrum on the target before the sputtering. A line q refers to an XPS spectrum on the target after the sputtering.

It has been confirmed that the Ti2p3/2 peak of the target after the sputtering is shifted to the lower energy side than that before the sputtering as indicated by a dotted line t in FIG. 5. Thus, it has been determined that the chemical state of titanium is changed between the target before the sputtering and the target after the sputtering.

### 3. OTHER EMBODIMENTS

The present invention is not to be considered limited to the embodiments of the invention described above, but various modifications and applications can be made without departing from the scope of the invention. For example, the form of the apparatus for applying a high frequency is not to be considered limited, but any form may be adopted as long as the high-frequency wave can be applied to Li₄Ti₅O₁₂.

In addition, for example, while a case of imparting conductivity to Li₄Ti₅O₁₂ by applying a high-frequency wave thereto has been described in the first embodiment, it is possible to impart conductivity to Li₄Ti₅O₁₂ even by methods other than the method of applying a high-frequency wave. Specifically, it is possible to impart conductivity to Li₄Ti₅O₁₂, for example, by applying a reduction treatment to Li₄Ti₅O₁₂ to change the chemical state of titanium. Examples of the reduction treatment include hydrogenation: reduction with the use of a hydrogen gas as a reducing agent; hydride reduction: reduction with the use of a hydride of a metal or a semimetal, or a complex compound (ate complex) thereof as a reducing agent; Clemmensen reduction: metal reduction with the use of a single metal for a reducing agent; reduction for reducing a carbonyl group of a ketone or an aldehyde to a methylene group; Birch reduction: reduction with the use of solvated electrons obtained by dissolving an alkali metal in liquid ammonia; Meerwein-Ponndorf-Verley reduction: reduction with the use of aluminum triisopropoxide [(i-PrO)₃Al] as a catalyst and isopropyl alcohol as a reducing agent and a solvent; Wolff-Kishner reduction: reduction for reducing a carbonyl group of a ketone or an aldehyde to a methylene group; and reduction in metal refining: a method of reduction with the use of carbon in a smelting furnace for reducing a metal oxide or a metal sulfide present in an ore to a single metal in the case of refining a metal such as iron and copper.

### REFERENCE SIGNS LIST

111 battery can

112, 113 insulating plate

114 battery can lid

115 safety valve mechanism

115A disk plate

116 heat-sensitive resistive element

117 gasket

120 rolled electrode body

121 positive electrode

122 negative electrode

123 separator

124 center pin

125 positive electrode lead

126 negative electrode lead

1. A method for producing a conducting material, comprising the step of carrying out treatment of applying a high-frequency wave to a Li₄Ti₅O₁₂ sintered body.

2. The method for producing a conducting material according to claim 1, wherein the treatment of applying the high-frequency wave is carried out in an atmosphere containing nitrogen.

3. The method for producing a conducting material according to claim 1, wherein the step of carrying out the treatment of applying the high-frequency wave to the Li₄Ti₅O₁₂ sintered body is a step of carrying out RF magnetron sputtering in an atmosphere containing nitrogen with the use of the Li₄Ti₅O₁₂ sintered body as a target.

4. A conducting material, wherein a chemical state of titanium has been changed by carrying out treatment of applying a high-frequency wave to a Li₄Ti₅O₁₂ sintered body.

5. The conducting material according to claim 4, comprising a Li₄Ti₅O₁₂ phase, an anatase-type TiO₂ phase, and a rutile-type TiO₂ phase.

6. A battery comprising:
a positive electrode;
a negative electrode; and
an electrolyte,
wherein the negative electrode contains, as an active material, a conducting material in which a chemical state of titanium has been changed by carrying out treatment of applying a high-frequency wave to a Li₄Ti₅O₁₂ sintered body.
